(19) United States
(12) Patent Application Publication
(10) Pub. No.: US 2009/0113962 A1
(43) Pub. Date: May 7, 2009

(54) Gordon Lockdown

(76) Inventor: Johnny Earl Gordon, Ceres, CA (US)

Correspondence Address: Johnny Earl Gordon;Gordon Machining Inc., 2500 Fiesta Way, Ceres, CA, 95307, US

(21) Appl. No.: 11/821,775

(22) Filed: Nov. 7, 2007

(51) Int. Cl. E05B 65/12

(52) U.S. Cl. 70/261

(57) ABSTRACT

A motorcycle seat like the one which comes stock on the 2007 HD street glide can easily be removed with a screwdriver, that's bad if the one with the screwdriver has criminal intent. The lock I have invented covers that screw up with a keyed lock preventing that unwanted person from easily removing it.

### CROSS-REFERENCE TO RELATED APPLICATIONS

None

### FEDERALLY SPONSORED RESEARCH

None

### SEQUENCE LISTING

None

### BACKGROUND

This invention relates to motorcycle seats,specifically to securing the rear of the seat to the rear fender in such away that a key is needed to remove it.

This seat lock was design to be used the 2007 Harley-Davidson Street Glide motorcycle. However the bracket which secures the seat to that cycle is the same on all models (the full dress touring cycles,the softail models, even the smaller sportster cycles)

Therefore, “The Gordon Lockdown” can be used on all Harley-Davidson motorcycle which have the same rear stock seat bracket as the Street Glide.

Because of the instructions given to most owners of motorcycles (don't tighten the screw on the rear of the seat to tight, but even if it was tight it would only take a screwdriver to steal the seat} There has been no one who has locked the seat down using that hold down screw at the rear of the seat

### SUMMARY

The invention is a very effective seat lock, with many advantages. To name a few, some seats cost as much as $2800.00 and if stolen would most surely be turned in as an insurance claim. The use of The Gordon Lockdown would limit such claims. However its been asked “are they stealing seats now? Yes they are. Most seats on the touring cycles cost less than $300.00, even the seat on the inspiring Street Glide cost $442.00 yet if stolen would no be reported to the insurance company. Because in most cases the deductible is $500.00. Then too as in the case of the chest bones on the human body which protect vital organs, the seat on a motorcycle protects its vital parts. Such as the battery (the heart of the cycle), the alarm system and all vital wiring.

To sum it up the seat is a very important part of a motorcycle that is why The Gordon Lockdown was invented.

### DRAWINGS

FIG. 1 is a perspective right view of a motorcycle seat with the seat lock installed.

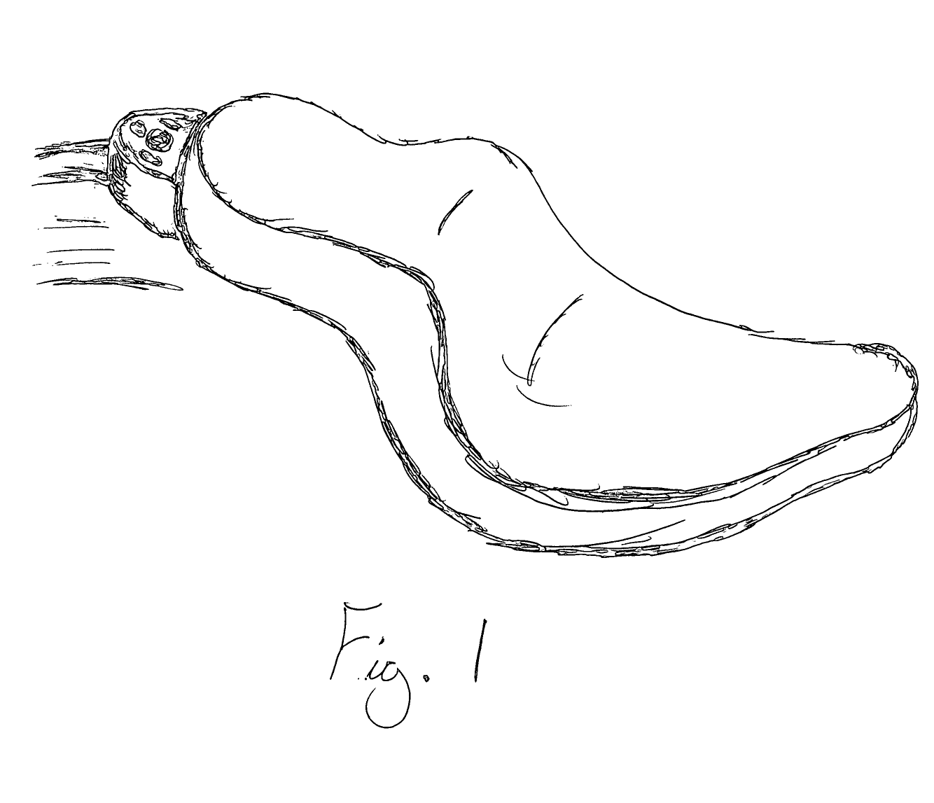

FIG. 2 is a perspective left-side view of the motorcycle seat in FIG. 1

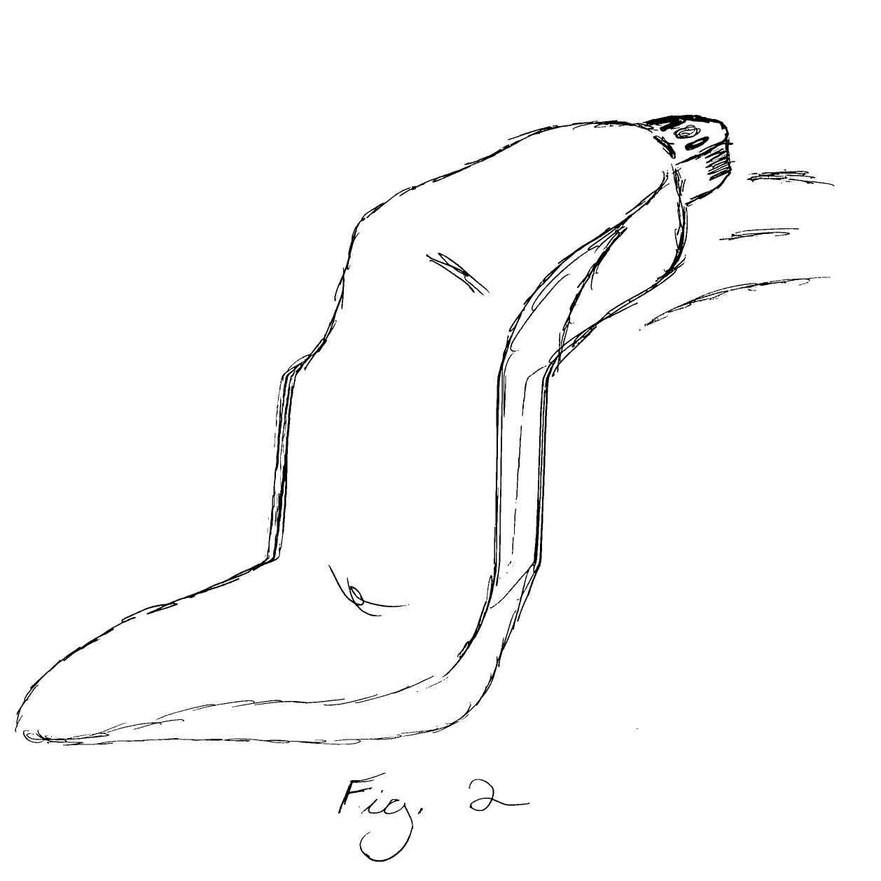

FIG. 3 is a right elevational view of a motorcycle seat lock not attached to a seat.

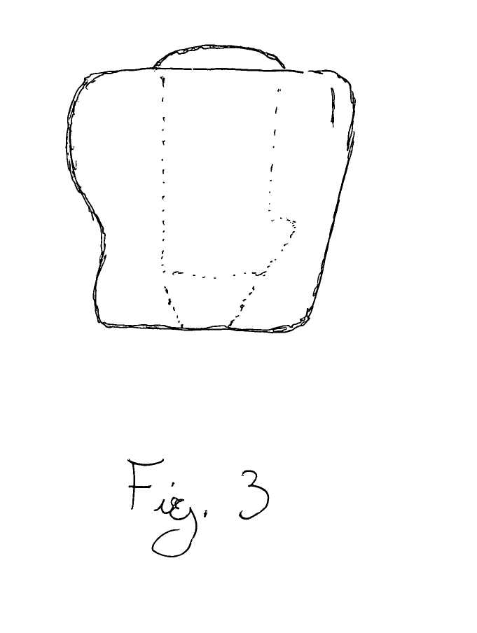

FIG. 4 is a front elevational view thereof;

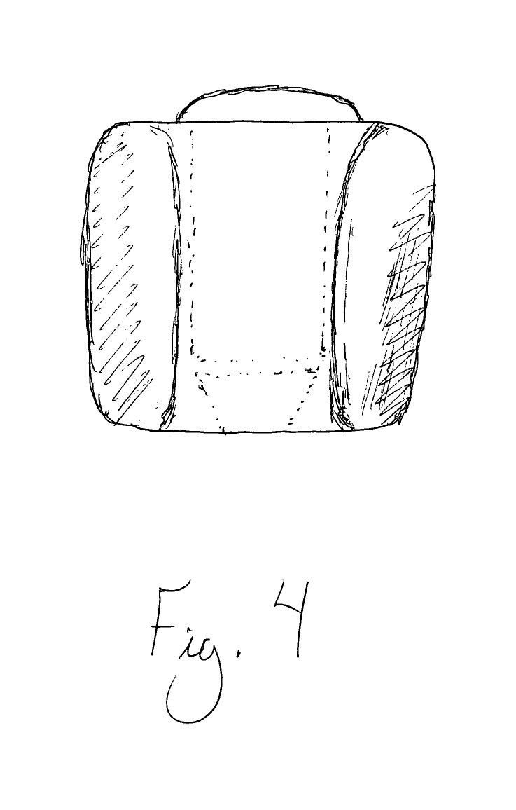

FIG. 5 is rear elevational view thereof (note the number pad for key identification).

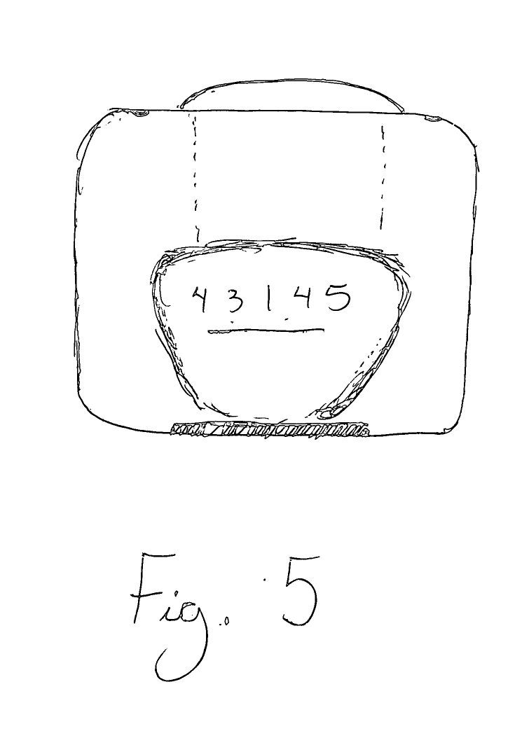

FIGS. 6, 7, 8 are top views of 3 styles of my new invention thereof;

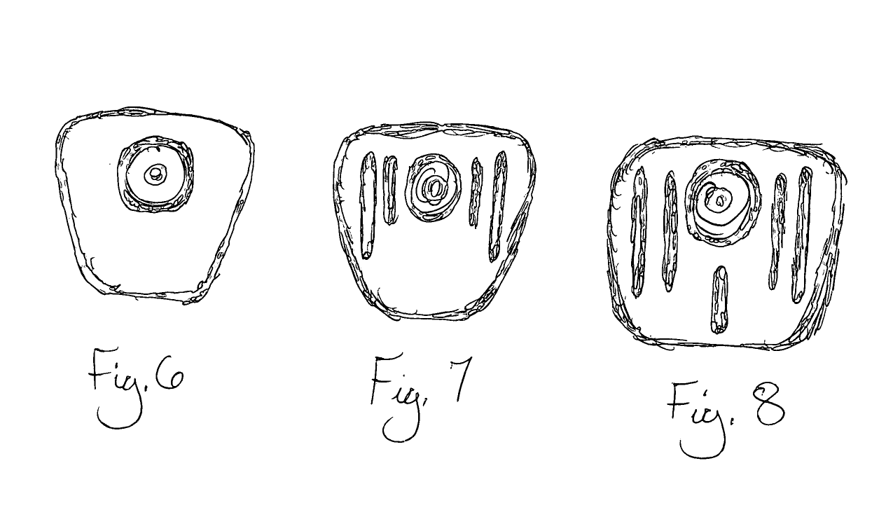

FIG. 9 is a bottom plan view thereof.

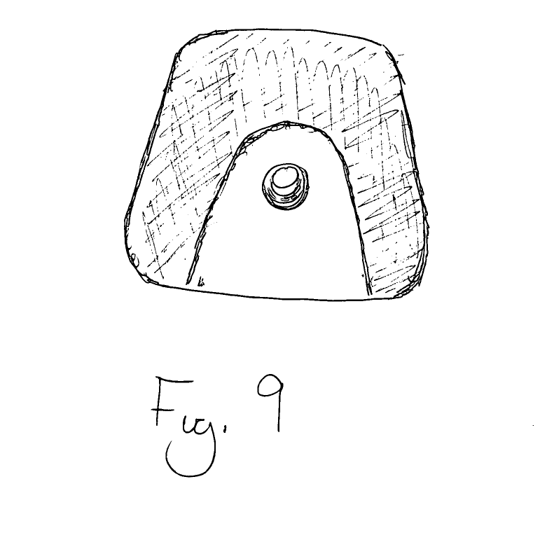

FIG. 10 is a side view of the hold down screw thereof;

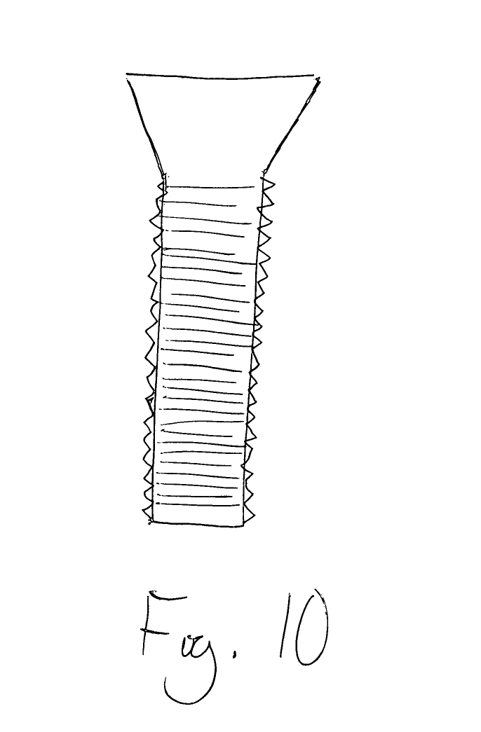

FIG. 11 is a right elevational view of the lock used to cover the screw thereof;

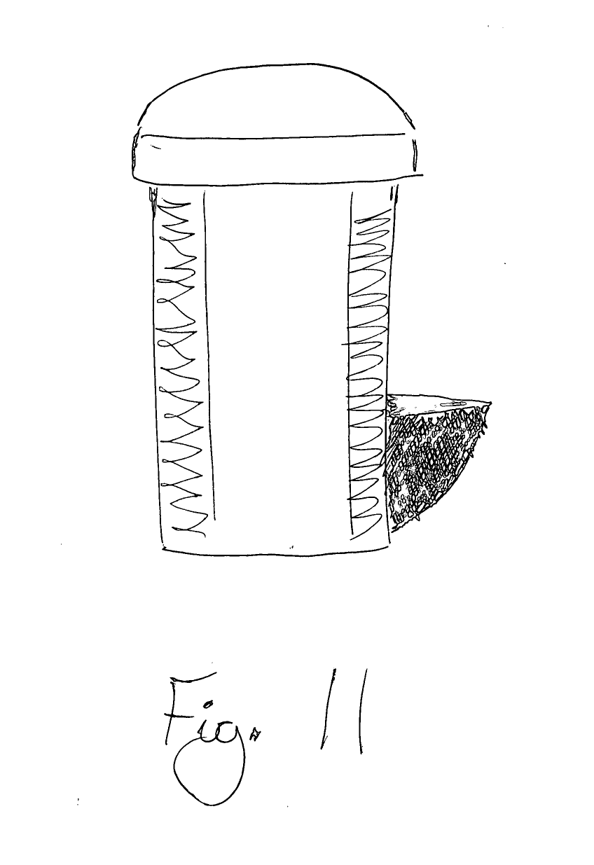

FIG. 12 is a top view of the bracket that is attached to the rear of the seat.

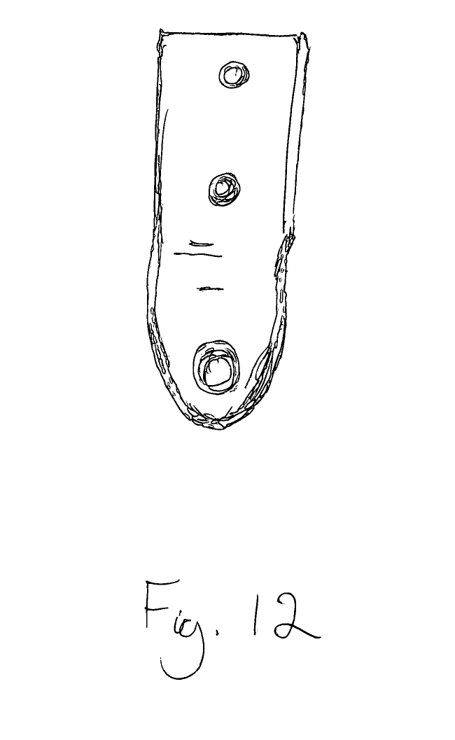

### REFERENCE NUMERALS

13. lock housing

14. number pad

15. seat bracket

16. flathead screw

17. lock

18. black catch

19. lock bracket step

### OPERATION

In operation the seat is installed as it normally is, with the addition of the lock housing 13 being set on top of the seat bracket 15 with the key pad 14 facing the front of the motorcycle, careful that the lock bracket step 19 is seated around the seat bracket 15. The flathead screw 16 is now inserted into the lock housing 13 and screwed tightly to the rear fender. The lock 17 is now inserted (with the black catch 18 facing the rear of the motorcycle) and pushed down until a click sound is heard which means the seat is now locked down.

1. What I claim as my invention is a seat lock comprising:
a lock housing made of light weight aluminum, ¼-20 flathead screw a cylinder lock and a touring seat with hold down bracket in rear whereby (a) The Gordon Lockdown seat lock when properly installed will eliminate the ten second steal of said seat, and protect the vital parts of the motorcycle under said seat, and (b) said lock when powder coated or polished to match the motorcycle, protect said seat and look good while its doing it.
